(19) United States
(12) Patent Application Publication
(10) Pub. No.: US 2025/0102821 A1
(43) Pub. Date: Mar. 27, 2025

(54) Camera With Curved Electromagnetics

(71) Applicant: Apple Inc., Cupertino, CA (US)

(72) Inventors: Andrew S. Jozefov, San Francisco, CA (US); Zachary W. Birnbaum, Santa Clara, CA (US)

(73) Assignee: Apple Inc., Cupertino, CA (US)

(21) Appl. No.: 18/473,121

(22) Filed: Sep. 22, 2023

(51) Int. Cl. G02B 27/64

(52) U.S. Cl. CPC G02B 27/64

(57) ABSTRACT

Various embodiments include a camera system that includes one or more voice coil motor (VCM) actuators having curved electromagnetics. In various embodiments, the VCM actuator(s) may include an optical image stabilization (OIS) VCM actuator configured to tilt/rotate a lens group, together with an image sensor, about multiple axes orthogonal to an optical axis of the camera system. Additionally, or alternatively, the VCM actuator(s) may include a theta-Z correction VCM actuator configured to rotate the lens group, together with the image sensor, about an axis parallel to the optical axis. The OIS VCM actuator and/or the theta-Z correction VCM actuator may have curved electromagnetics.

### BACKGROUND

### Technical Field

This disclosure relates generally to a camera that includes one or more voice coil motor (VCM) actuators having curved electromagnetics.

### Description of the Related Art

The advent of small, mobile multipurpose devices such as smartphones and tablet or pad devices has resulted in a need for high-resolution, small form factor cameras for integration in the devices. Some small form factor cameras may incorporate optical image stabilization (OIS) mechanisms that may sense and react to external excitation/disturbance by adjusting location of the optical lens on the X and/or Y axis in an attempt to compensate for unwanted motion of the lens. Some small form factor cameras may incorporate an autofocus (AF) mechanism whereby the object focal distance can be adjusted to focus an object plane in front of the camera at an image plane to be captured by the image sensor. In some such autofocus mechanisms, the optical lens is moved as a single rigid body along the optical axis of the camera to refocus the camera.

### BRIEF DESCRIPTION OF THE DRAWINGS

FIGS. 1A-1B illustrate views of an example camera system that may include one or more voice coil motor (VCM) actuators having curved electromagnetics, in accordance with some embodiments. FIG. 1A shows an exploded perspective view of the camera system. FIG. 1B shows a collapsed perspective view of the camera system.

FIGS. 2A-2E illustrate views of an example VCM actuator arrangement 200, with curved electromagnetics, that may be included in a camera system, in accordance with some embodiments. FIG. 2A shows a perspective view of the VCM actuator arrangement. FIG. 2B shows a perspective view of the VCM actuator arrangement including an optical image stabilization (OIS) VCM actuator. FIG. 2C shows a schematic side view of example aspects of electromagnetic interaction between an OIS drive magnet and an OIS drive coil of the OIS VCM actuator. FIG. 2D shows a perspective view of the VCM actuator arrangement including a theta-Z correction VCM actuator. FIG. 2E shows a schematic side view of example aspects of electromagnetic interaction between a theta-Z magnet and a theta-Z coil of the theta-Z correction VCM actuator.

FIG. 3 illustrates an example graph and indicates example differences, with respect to Lorentz stroke versus stroke, between curved electromagnetics and non-curved electromagnetics, in accordance with some embodiments.

FIGS. 4A-4B illustrate views indicating example differences, with respect to consistency of distance across a stroke range, between non-curved electromagnetics and curved electromagnetics, in accordance with some embodiments. FIG. 4A shows a schematic side cross-sectional view of example non-curved electromagnetics.

FIG. 4B shows a schematic side cross-sectional view of example curved electromagnetics.

FIGS. 5A-5C illustrate views of an example set of curved electromagnetics 500 that may be included in a camera system, in accordance with some embodiments. FIG. 5A shows a side view of the set of curved electromagnetics.

FIG. 5B shows a side cross-sectional view of the set of curved electromagnetics.

FIG. 5C shows a perspective view of a curved magnet of the set of curved electromagnetics.

FIGS. 6A-6C illustrate views of another example set of curved electromagnetics that may be included in a camera system, in accordance with some embodiments. FIG. 6A shows a side view of the set of curved electromagnetics.

FIG. 6B shows a side cross-sectional view of the set of curved electromagnetics.

FIG. 6C shows a perspective view of a curved magnet of the set of curved electromagnetics.

FIGS. 7A-7C illustrate views of yet another example set of curved electromagnetics that may be included in a camera system, in accordance with some embodiments. FIG. 7A shows a side view of the set of curved electromagnetics.

FIG. 7B shows a side cross-sectional view of the set of curved electromagnetics.

FIG. 7C shows a perspective view of a curved/stacked coil of the set of curved electromagnetics.

FIGS. 8A-8D illustrate views of another example set of curved electromagnetics that may be included in a camera system, in accordance with some embodiments. FIG. 8A shows a side view of the set of curved electromagnetics.

FIG. 8B shows a side cross-sectional view of the set of curved electromagnetics.

FIG. 8C shows a perspective view of a curved/stacked coil of the set of curved electromagnetics. FIG. 8D shows a top view of the set of curved electromagnetics.

FIGS. 9A-9C illustrate views of yet another example set of curved electromagnetics that may be included in a camera system, in accordance with some embodiments. FIG. 9A shows a side view of the set of curved electromagnetics.

FIG. 9B shows a side cross-sectional view of the set of curved electromagnetics.

FIG. 9C shows a perspective view of a curved magnet stack of the set of curved electromagnetics.

FIGS. 10A-10B illustrate views of still yet another example set of curved electromagnetics that may be included in a camera system, in accordance with some embodiments. FIG. 10A shows a top view of the set of curved electromagnetics as used in the camera system for theta-Z correction/compensation. FIG. 10B shows a perspective view of the set of curved electromagnetics.

FIG. 11 illustrates a schematic representation of an example environment comprising a device that may include a camera system with curved electromagnetics, in accordance with some embodiments.

FIG. 12 illustrates a schematic block diagram of an example environment comprising a computer system that may include a camera system with curved electromagnetics, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises.” and/or “comprising.” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments include a camera system that includes one or more voice coil motor (VCM) actuators having curved electromagnetics. In various embodiments, the VCM actuator(s) may include an optical image stabilization (OIS) VCM actuator configured to tilt/rotate a lens group, together with an image sensor, about multiple axes orthogonal to an optical axis of the camera system. Additionally, or alternatively, the VCM actuator(s) may include a theta-Z correction VCM actuator configured to rotate the lens group, together with the image sensor, about an axis parallel to the optical axis. The OIS VCM actuator and/or the theta-Z correction VCM actuator may have curved electromagnetics.

In various camera applications (e.g., smartphone cameras), there is a drive for improved optical performance in increasingly compact devices. Traditional OIS actuators may be configured to tilt or translate the lens relative to the image sensor to prevent optical distortion and to produce stable images in the presence of a disturbance. Gimbal tilt actuators, which may be configured to tilt/rotate the lens group and the image sensor as a pair, allow for larger OIS compensation by facilitating larger tilt angles relative to lens shift architectures, thus improving camera tilt OIS performance and reducing blurry images.

Various embodiments disclosed herein include electromagnetic architectures with curved magnet and coil geometry to enable gimbal-type VCM actuators to achieve longer stroke, improved linearity over stroke, and increased power efficiency in a compact package. Curved electromagnetic components may produce a more uniform Lorentz force output throughout rotation over a stroke range. Furthermore, curved electromagnetics may allow for larger module tilt angles. The increase in gimbal tilt may allow for greater OIS compensation angles to capture higher quality stable images and video without introducing blurry pixels in the corners of the image.

According to some embodiments, the camera system may include a lens group, an image sensor, and one or more VCM actuators for rotating at least one of the lens group or the image sensor. The VCM actuator(s) may include one or more magnet-coil groups having curved electromagnetics. For example, a magnet-coil group may include one or more magnets and one or more coils. The magnet(s) may form a first curvature of the curved electromagnetics. The coil(s) may form a second curvature of the curved electromagnetics. In the magnet-coil group, the coil(s) may be positioned proximate the magnet(s) such that, when driven with an electric current, the coil(s) are capable of electromagnetically interacting with the magnet(s) to produce Lorentz forces that rotate at least one of the lens group or the image sensor.

According to various embodiments, one of the first curvature (of the magnet(s)) and the second curvature (of the coil(s)) is convex, and the other of the first curvature and the second curvature is concave. As a non-limiting example, the magnet(s) may comprise a concave side having the first curvature, and the coil(s) may comprise a convex side having the second curvature. The concave side of the magnet(s) may face the convex side of the coil(s). As another non-limiting example, the magnet(s) may comprise a convex side having the first curvature, and the coil(s) may comprise a concave side having the second curvature. The convex side of the magnet(s) may face the concave side of the coil(s). In various embodiments, the first curvature may trace a first arc, and the second curvature may trace a second arc that is concentric with the first arc.

In some embodiments, the magnet(s) in a magnet-coil group may include multiple magnets arranged in a curved magnet stack to form the first curvature. Additionally, or alternatively, the coil(s) in the magnet-coil group may include a stacked coil that has wire strands stacked to form the second curvature.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

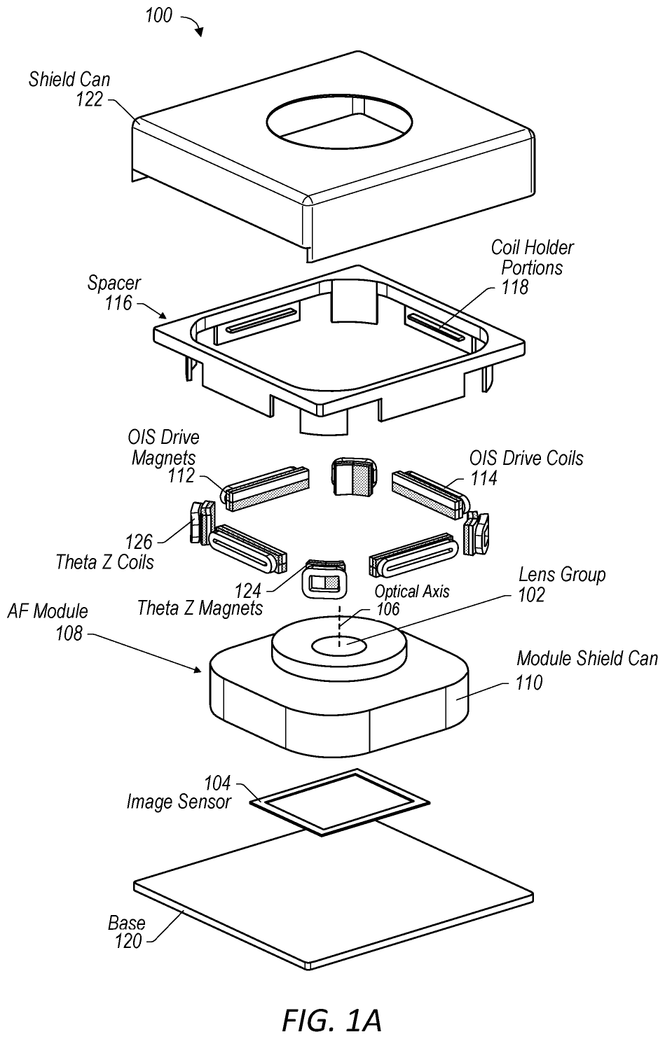

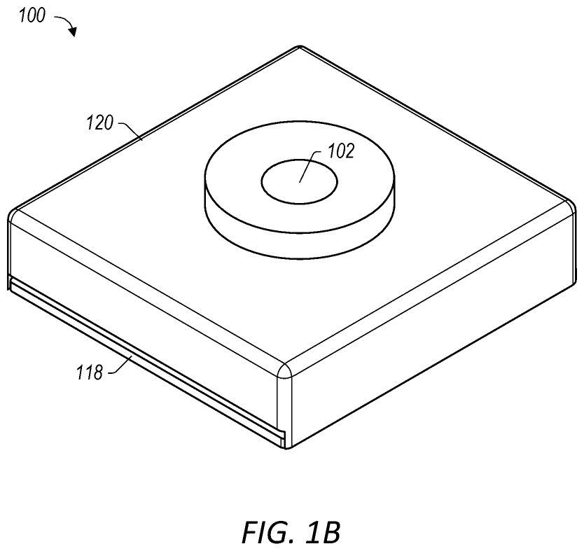

FIGS. 1A-1B illustrate views of an example camera system 100 that may include one or more voice coil motor (VCM) actuators having curved electromagnetics, in accordance with some embodiments. FIG. 1A shows an exploded perspective view of the camera system 100. FIG. 1B shows a collapsed perspective view of the camera system 100.

According to various embodiments, the camera system 100 may include a lens group 102, an image sensor 104, and/or one or more actuators. For example, the actuator(s) may include an autofocus (AF) actuator and/or an optical image stabilization (OIS) actuator. In some embodiments, the AF actuator may be configured to move the lens group 102 and/or the image sensor 104 in directions parallel to an optical axis 106 of the camera system 100. As indicated in FIG. 1A, the camera system 100 may include an AF module 108, which may include an AF actuator that moves the lens group 102, relative to the image sensor 104, in directions parallel to the optical axis 106. In some embodiments, the AF module 108 may include a module shield can 110, which may encase at least a portion of the AF module 108.

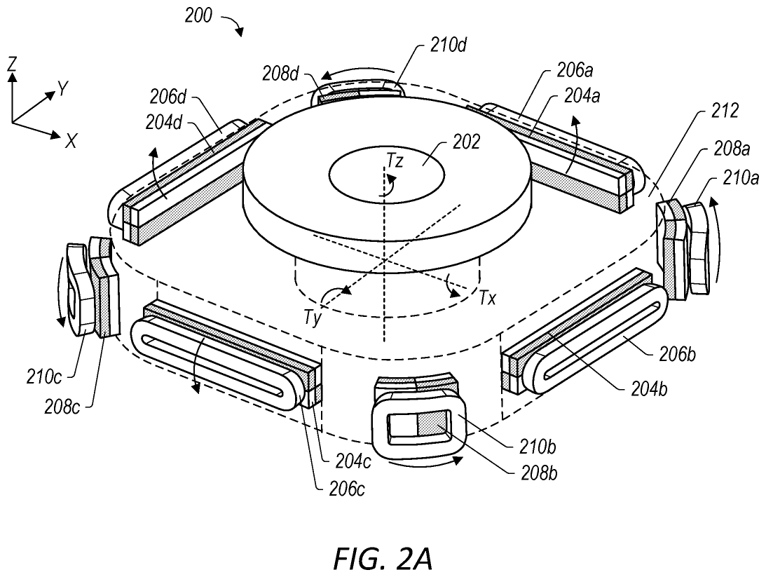

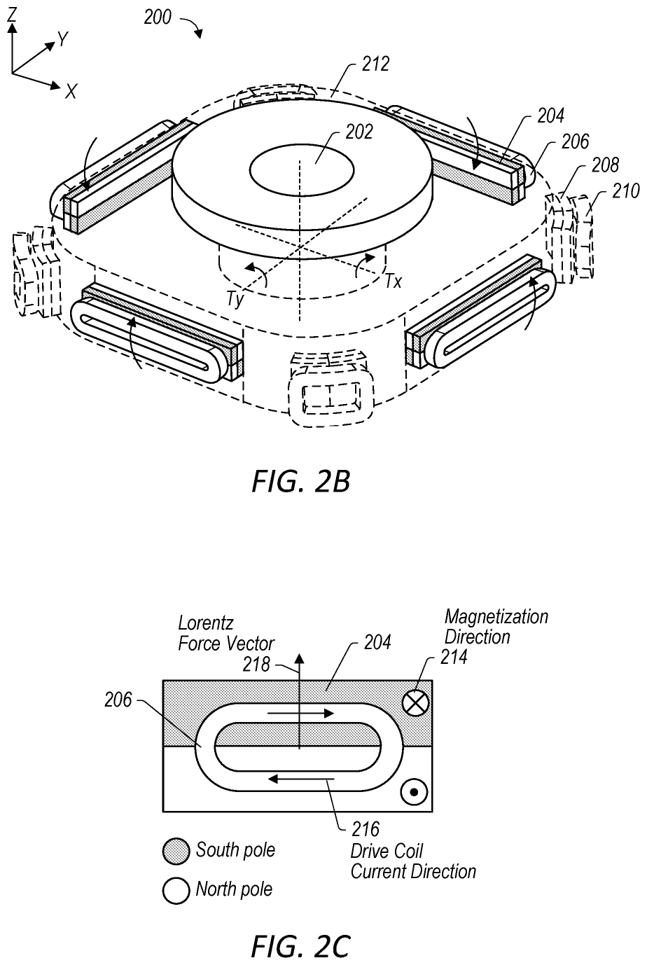

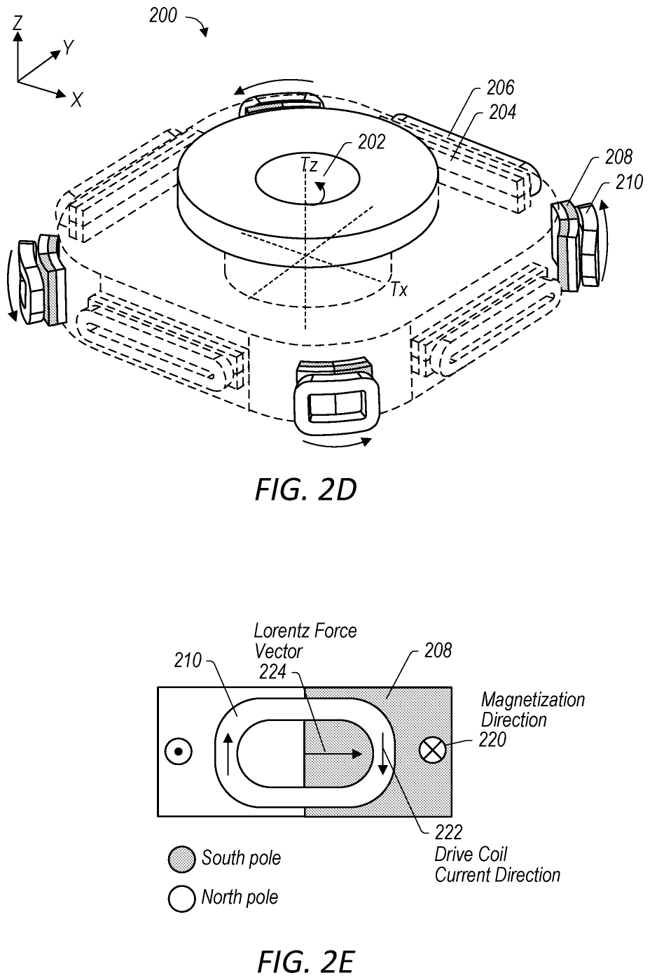

In various embodiments, the actuator(s) may include an OIS voice coil motor (VCM) actuator. For example, the OIS VCM actuator may include one or more OIS drive coils 112 and one or more OIS drive magnets 114. As will be discussed in further detail herein with reference to FIGS. 2A-9C, the OIS VCM actuator may have curved electromagnetics. In some non-limiting embodiments, OIS drive magnet(s) 114 may have a curved surface (and/or otherwise enable a curved electromagnetic interface with the OIS drive coil(s) 112), and the OIS drive coil(s) 112 may have a curved surface (and/or otherwise enable a curved electromagnetic interface with the OIS drive magnet(s) 114).

In various embodiments, the camera system 100 may include a spacer 116 (which may also be referred to herein as a “coil holder,” as it may include coil holder portion(s) 118, as indicated in FIG. 1A), a base 120, and/or a shield can 122. The OIS drive magnet(s) 112 may be fixedly coupled with the AF module 108 in some embodiments. For example, the OIS drive magnet(s) 112 may be attached to sides of the module shield can 110 in some embodiments. The OIS drive coil(s) 114 may be fixedly coupled with one or more stationary structures of the camera system 100. For example, in some embodiments, the spacer 116 may be coupled with the shield can 122 and/or the base 120, and the OIS drive coil(s) 114 may be attached to the spacer 116. While some non-limiting examples of magnets and coils described herein may indicate that the magnets are movable and the coils are fixed (relative to the magnets), it should be understood that in various embodiments the coils may be movable, and the magnets may be fixed.

According to various embodiments, a respective OIS drive coil 114 may be located proximate a respective OIS drive magnet 112 such that, when driven with an electric current, the respective OIS drive coil 114 is capable of electromagnetically interacting with the respective OIS drive magnet 112 to enable OIS motion. In various embodiments, to implement OIS motion, the OIS VCM actuator may be configured to rotate/tilt the lens group 102, together with the image sensor 104, about multiple axes orthogonal to the optical axis 106.

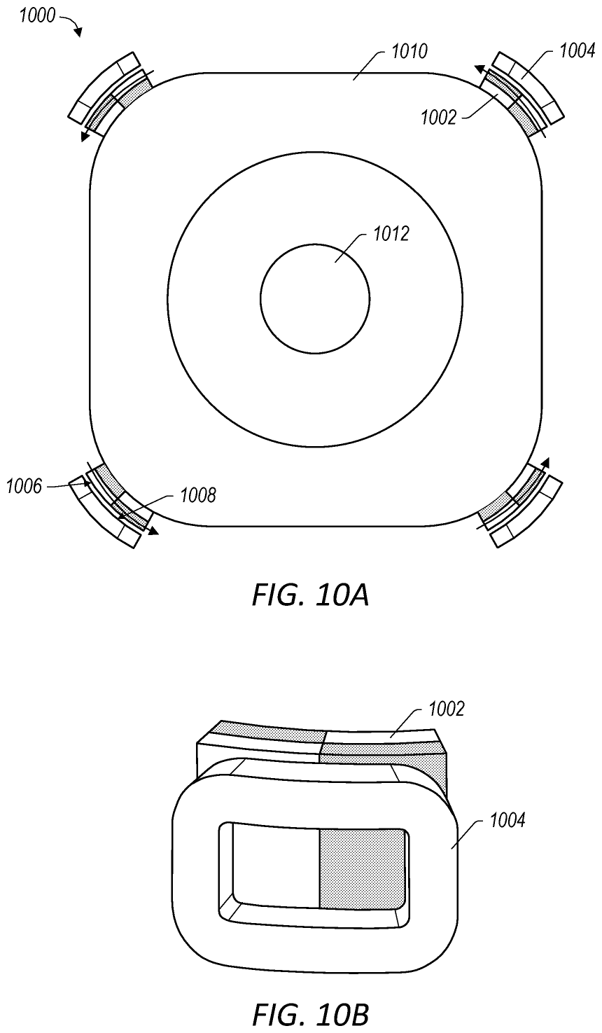

In some embodiments, the actuator(s) may include a theta-Z correction VCM actuator. As will be discussed in further detail herein with reference to FIGS. 2A-2E and 10A-10B, the theta-Z correction VCM actuator may have curved electromagnetics. The theta-Z correction VCM actuator may be configured to rotate the lens group 102, together with the image sensor 104, about an axis parallel to the optical axis 106. According t various embodiments, the theta-Z correction actuator may include one or more theta-Z magnets 124 and one or more theta-Z coils 126. The theta-Z magnet(s) 124 may be fixedly coupled with the AF module 108. For example, the theta-Z magnet(s) 124 may be attached to corner portions of the module shield can 110 in some embodiments, e.g., as indicated in FIG. 1A. The theta-Z coil(s) 126 may be fixedly coupled with one or more stationary structures (e.g., the spacer 116) of the camera system 100.

In various embodiments, a respective theta-Z coil 126 may be located proximate a respective theta-Z magnet 124 such that, when driven with an electric current, the respective theta-Z coil 126 is capable of electromagnetically interacting with the respective theta-Z magnet 124 to enable theta-Z motion (rotation about an axis parallel to the optical axis 106).

FIGS. 2A-2E illustrate views of an example voice coil motor (VCM) actuator arrangement 200, with curved electromagnetics, that may be included in a camera system (e.g., camera system 100 in FIG. 1), in accordance with some embodiments. FIG. 2A shows a perspective view of the VCM actuator arrangement 200. FIG. 2B shows a perspective view of the VCM actuator arrangement including an optical image stabilization (OIS) VCM actuator. FIG. 2C shows a schematic side view of example aspects of electromagnetic interaction between an OIS drive magnet and an OIS drive coil of the OIS VCM actuator. FIG. 2D shows a perspective view of the VCM actuator arrangement 200 including a theta-Z correction VCM actuator. FIG. 2E shows a schematic side view of example aspects of electromagnetic interaction between a theta-Z magnet and a theta-Z coil of the theta-Z correction VCM actuator.

According to various embodiments, the VCM actuator arrangement 200 may include an OIS VCM actuator and/or a theta-Z correction VCM actuator. The camera system may include a lens group 202, an image sensor (e.g., image sensor 104 in FIG. 1A; not shown in FIGS. 2A-2E), among other camera components. The OIS VCM actuator may include one or more OIS drive magnets 204 and one or more OIS drive coils 206. The theta-Z correction VCM actuator may include one or more theta-Z magnets 208 and one or more theta-Z coils 210. According to various embodiments, the OIS VCM actuator and/or the theta-Z correction VCM actuator may be used to move the lens group 202 together with the image sensor to implement OIS and/or theta-Z correction.

In various embodiments, a respective OIS drive coil 206 may be located proximate a respective OIS drive magnet 204 such that, when driven with an electric current, the respective OIS drive coil 206 is capable of electromagnetically interacting with the respective OIS drive magnet 204 to enable OIS motion. According to various embodiments, to implement OIS motion, the OIS VCM actuator may be configured to rotate/tilt the lens group 202, together with the image sensor, about multiple axes orthogonal to an optical axis (e.g., optical axis 106 in FIG. 1) of the camera system.

According to various embodiments, the OIS drive magnet(s) 204 may include a first OIS drive magnet 204a, a second OIS drive magnet 204b, a third OIS drive magnet 204c, and/or a fourth OIS drive magnet 204d. The OIS drive coil(s) 206 may include a first OIS drive coil 206a, a second OIS drive coil 206b, a third OIS drive coil 206c, and/or a fourth OIS drive coil 206d. In some embodiments, the OIS drive magnet(s) 204 may be coupled with one or more movable components. For example, the movable components may include an autofocus (AF) module (e.g., AF module 108 in FIG. 1A) having a module shield can 212 (e.g., similar to, or the same as, module shield can 110 in FIG. 1A).

According to some embodiments, the first OIS drive magnet 204a may be attached to the module shield can 212 at a first side of the module shield can 212 (and/or a first side of the camera system). The second OIS drive magnet 204b may be attached to the module shield can 212 at a second side of the module shield can 212 (and/or a second side of the camera system). The third OIS drive magnet 204c may be attached to the module shield can 212 at a third side of the module shield can 212 (and/or a third side of the camera system) opposite the first side. The fourth OIS drive magnet 204d may be attached to the module shield can 212 at a fourth side of the module shield can 212 (and/or a fourth side of the camera system) opposite the second side.

In some embodiments, the OIS drive coil(s) 206 may be coupled with one or more stationary components (not shown) of the camera system. For example, the stationary component(s) may include a spacer (e.g., spacer 116 in FIG. 1A) and/or a coil holder. According to some embodiments, the first OIS drive coil 206a may be attached to the stationary component(s) at the first side, proximate the first OIS drive magnet 204a. The second OIS drive coil 206b may be attached to the stationary component(s) at the second side, proximate the second OIS drive magnet 204b. The third OIS drive coil 206c may be attached to the stationary component(s) at the third side, proximate the third OIS drive magnet 204c. The fourth OIS drive coil 206d may be attached to the stationary component(s) at the fourth side, proximate the fourth OIS drive magnet 204d.

As previously mentioned, FIG. 2C shows example aspects of electromagnetic interaction between an OIS drive magnet 204 and an OIS drive coil 206. According to some non-limiting embodiments, OIS drive magnet 204 may have a south magnetic pole positioned above a north magnetic pole, and the magnetization direction 214 may be such that the magnetic field is coming out of the page from the north magnetic pole and going into the page toward the south magnetic pole, as indicated in FIG. 2C. Furthermore, an electric current (also referred to herein as a “drive current”) may flow through the OIS drive coil 206 in a drive coil current direction 216 in a clockwise direction. Based on the magnetization direction 214 and the drive coil current direction 216, the electromagnetic interaction between the OIS drive magnet 204 and the OIS drive coil 206 may produce a Lorentz force vector 218 having an upward direction, as indicated in FIG. 2C. To produce a Lorentz force vector in the opposite (e.g., downward direction), the electric current may be supplied to the OIS drive coil 206 in the opposite direction (e.g., counter-clockwise).

As indicated in FIG. 2A, such electromagnetic interactions between corresponding pairs of OIS drive magnets 204 and OIS drive coils 206 may produce Lorentz forces that can tilt the lens group 202, together with the image sensor, about multiple axes orthogonal to the optical axis. For example, one or more drive currents may be used to drive the first OIS drive coil 206a and/or the third OIS drive coil 206c to tilt the lens group 202, together with the image sensor, about a first axis (e.g., axis Tₓ indicated in FIGS. 2A, 2B, and 2D) orthogonal to the optical axis. In some embodiments, the tilt direction about axis Tₓ may be based at least in part on the drive current(s) supplied to the first OIS drive coil 206a and/or the third OIS drive coil 206c, the winding direction(s) of those OIS drive coils, and/or the magnetic polar orientation(s) of the first OIS drive magnet 204a and/or the third OIS drive magnet 204c.

According to various embodiments, one or more drive currents may be used to drive the second OIS drive coil 206b and/or the fourth OIS drive coil 206d to tilt the lens group 202, together with the image sensor, about a second axis (e.g., axis Ty indicated in FIGS. 2A, 2B, and 2D) orthogonal to the optical axis and orthogonal to the first axis (axis Tₓ). In some embodiments, the tilt direction about axis Ty may be based at least in part on the drive current(s) supplied to the second OIS drive coil 206b and/or the fourth OIS drive coil 206d, the winding direction(s) of those OIS drive coils, and/or the magnetic polar orientation(s) of the second OIS drive magnet 204b and/or the fourth OIS drive magnet 204d.

In various embodiments, a respective theta-Z coil 210 may be located proximate a respective theta-Z magnet 208 such that, when driven with an electric current, the respective theta-Z coil 210 is capable of electromagnetically interacting with the respective theta-Z magnet 208 to enable theta-Z motion. According to various embodiments, to implement theta-Z motion, the theta-Z correction VCM actuator may be configured to rotate the lens group 202, together with the image sensor, about an axis parallel to the optical axis.

According to various embodiments, the theta-Z magnet(s) 208 may include a first theta-Z magnet 208a, a second theta-Z magnet 208b, a third theta-Z magnet 208c, and/or a fourth theta-Z magnet 208d. The theta-Z coil(s) 210 may include a first theta-Z coil 210a, a second theta-Z coil 210b, a third theta-Z coil 210c, and/or a fourth theta-Z coil 210d. In some embodiments, the theta-Z magnet(s) may be coupled with one or more movable components, such as the AF module having the module shield can 212.

According to some embodiments, the first theta-Z magnet 208a may be attached to the module shield can 212 at a first corner portion of the module shield can 212 (and/or a first corner portion of the camera system). The second theta-Z magnet 208b may be attached to the module shield can 212 at a second corner portion of the module shield can 212 (and/or a second corner portion of the camera system). The third theta-Z magnet 208c may be attached to the module shield can 212 at a third corner portion of the module shield can 212 (and/or a third corner portion of the camera system) opposite (e.g., diagonal to) the first corner portion. The fourth theta-Z magnet 208d may be attached to the module shield can 212 at a fourth corner portion of the module shield can 212 (and/or a fourth corner portion of the camera system) opposite (e.g., diagonal to) the second corner portion.

In some embodiments, the theta-Z coil(s) 210 may be coupled with one or more stationary components (not shown), such as the previously mentioned spacer/coil holder. According to some embodiments, the first theta-Z coil 210a may be attached to the stationary component(s) at the first corner portion, proximate the first theta-Z magnet 208a. The second theta-Z coil 210b may be attached to the stationary component(s) at the second corner portion, proximate the second theta-Z magnet 208b. The third theta-Z coil 210c may be attached to the stationary component(s) at the third corner portion, proximate the third theta-Z magnet 208c. The fourth theta-Z coil 210d may be attached to the stationary component(s) at the fourth corner portion, proximate the fourth theta-Z magnet 208d.

As previously mentioned, FIG. 2E shows example aspects of electromagnetic interaction between a theta-Z magnet 208 and a theta-Z coil 210. According to some non-limiting embodiments, the theta-Z magnet 208 may have a north magnetic pole positioned to the left of a south magnetic pole, and the magnetization direction 220 may be such that the magnetic field is coming out of the page from the north magnetic pole and going into the page toward the south magnetic pole, as indicated in FIG. 2E. Furthermore, a drive current may flow through the theta-Z coil 210 in a drive coil current direction 222 in a clockwise direction. Based on the magnetization direction 220 and the drive coil current direction 222, the electromagnetic interaction between the theta-Z magnet 208 and the theta-Z coil 210 may produce a Lorentz force vector 224 having a first direction (e.g., rightward, as indicated in FIG. 2E). To produce a Lorentz force vector in the opposite direction (e.g., a second, leftward direction), the electric current may be supplied to the theta-Z coil 210 in the opposite direction (e.g., counter-clockwise).

As indicated in FIG. 2A, such electromagnetic interactions between corresponding pairs of theta-Z magnets 208 and theta-Z coils 210 may produce Lorentz forces that can rotate the lens group 202, together with the image sensor, about an axis parallel to the optical axis. For example, one or more drive currents may be used to drive one or more of the theta-Z coils 210 to rotate the lens group 202, together with the image sensor, in a first direction (e.g., counter-clockwise, as indicated in FIG. 2D) about axis T_{z}. Similarly, one or more drive currents may be used to drive one or more of the theta-Z coils 210 to rotate the lens group 202, together with the image sensor, in a second direction (e.g., clockwise), opposite the first direction, about axis T_{z}. In some embodiments, the rotation direction about axis T_{z} may be based at least in part on the drive current(s) supplied to the theta-Z coils 210, the winding direction(s) of the theta-Z coils 210, and/or the magnetic polar orientation(s) of the theta-Z magnets 208.

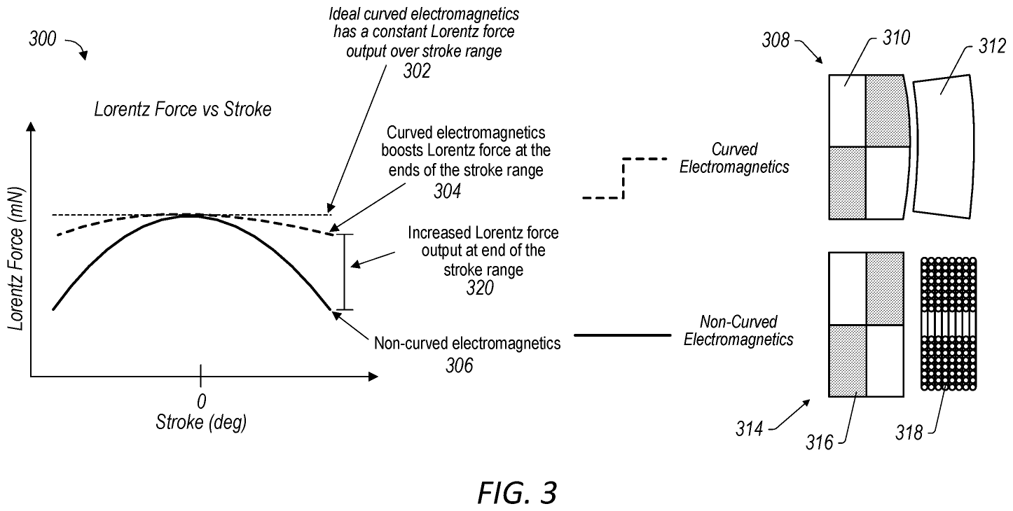

FIG. 3 illustrates an example graph 300 and indicates example differences, with respect to Lorentz stroke versus stroke, between curved electromagnetics and non-curved electromagnetics, in accordance with some embodiments. In graph 300, the X-axis represents an amount of stroke (in degrees), and the Y-axis represents an amount of Lorentz force (in millinewtons (mN)). The amount of stroke in graph 300 may be associated with an amount of rotation of a voice coil motor (VCM) electromagnetic component relative to another VCM electromagnetic component. For example, the amount of rotation may relate to rotation of a magnet relative to a corresponding coil in some embodiments. Additionally, or alternatively, the amount of rotation may relate to rotation of a coil relative to a corresponding magnet. According to some non-limiting embodiments, the VCM electromagnetic components may be part of an OIS VCM actuator and/or a theta-Z correction VCM actuator, such as those described in the present disclosure. Furthermore, the amount of Lorentz force in graph 300 may be associated with an amount of Lorentz force produced by the VCM electromagnetic components across various stroke positions.

In graph 300, three example curves-a first curve 302, a second curve 304, and a third curve 306—are plotted for comparison and illustrative purposes. The first curve 302 represents an example of Lorentz force produced across various stroke positions with ideal curved electromagnetics. The second curve 304 represents an example of Lorentz force produced across various stroke positions with example curved electromagnetics 308, e.g., as represented in the schematic side cross-sectional view at the right side of FIG. 3. The curved electromagnetics 308 may include a curved magnet 310 (e.g., a movable magnet) and a corresponding curved coil 312 (e.g., a fixed coil that is stationary relative to the tilt/rotation of the magnet). The third curve 306 represents an example of Lorentz force produced across various stroke positions with example non-curved electromagnetics 314, e.g., as represented in the schematic side cross-sectional view at the right side of FIG. 3. The non-curved electromagnetics 314 may include a non-curved magnet 316 (e.g., a movable magnet) and a corresponding non-curved coil 318 (e.g., a fixed coil that is stationary relative to the tilt/rotation of the magnet).

Regarding the curved electromagnetics 308, each of the curved magnet 310 and the curved coil 312 may have a respective curved surface. The curved surface of the curved magnet 310 may face the curved surface of the curved coil 312. According to various non-limiting embodiments, one of the curved surfaces may be convex (e.g., as is the curved magnet's 310 curved surface in the illustrated example) and the other of the curved surfaces may be concave (e.g., as is the curved coil's 312 curved surface in the illustrated example). Unlike with the curved electromagnetics 308, in the non-curved electromagnetics 314 the non-curved magnet 316 and the non-curved coil 318 may have respective non-curved surfaces that face each other.

As indicated in graph 300, the first curve 302 illustrates that the ideal curved electromagnetics have a constant Lorentz force output over the stroke range. The second curve 304 illustrates an example of how Lorentz force output may be boosted at the ends of the stroke range using the curved electromagnetics 308, relative to the Lorentz force output over the stroke range using the non-curved electronics 314 (illustrated in the third curve 306). In graph 300, vertical distance 320 is used to indicate an example of the increase in Lorentz force output over the stroke range using the curved electromagnetics 308, e.g., relative to using the non-curved electromagnetics 314.

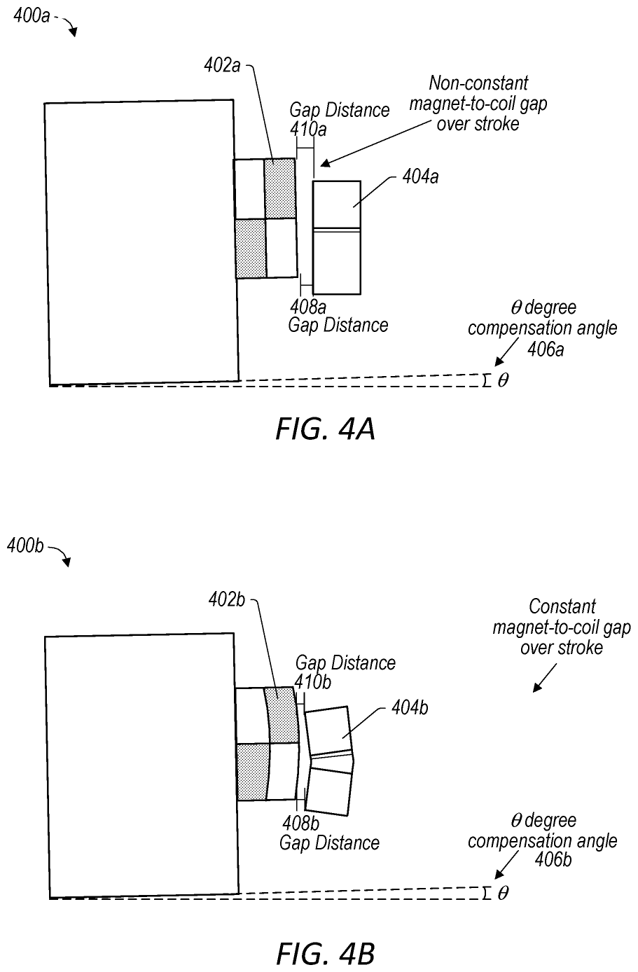

FIGS. 4A-4B illustrate views indicating example differences, with respect to consistency of distance across a stroke range, between non-curved electromagnetics and curved electromagnetics, in accordance with some embodiments. FIG. 4A shows a schematic side cross-sectional view of example non-curved electromagnetics 400a. FIG. 4B shows a schematic side cross-sectional view of example curved electromagnetics 400b.

As indicated in FIG. 4A, in some other camera designs having non-curved electromagnetics 400a used for tilt/rotation (e.g., as compared to the camera systems with curved electromagnetics described herein), tilt motion of one electromagnetic component relative to another may result in varying gap distance across a stroke range. The non-curved electromagnetics 400a may include a non-curved magnet 402a and a non-curved coil 404a. In a non-limiting example, the non-curved magnet 402a may be coupled with one or more movable components (e.g., as indicated in FIG. 4A), and the non-curved coil 404a may be “fixed” in the sense that it may remain stationary relative to tilt/rotation of the non-curved magnet 402a. It should be understood that, in various other embodiments, the coil may be movable, and the magnet may be fixed.

In the non-limiting example shown in FIG. 4A, electromagnetic interaction between the non-curved electromagnetics 400a may cause the non-curved magnet 402a to tilt (e.g., by Θ degree compensation angle 406a), relative to the non-curved coil 404a, resulting in a non-constant magnet-to-coil gap, as indicated by the difference between gap distance 408a and gap distance 410a.

As indicated in FIG. 4B, in various embodiments of camera systems having curved electromagnetics 400b used for tilt/rotation (e.g., as compared to the other camera designs having non-curved electromagnetics, as discussed herein with reference to at least FIG. 4A), tilt motion of one electromagnetic component relative to another may enable maintenance of a constant gap distance across a stroke range. The curved electromagnetics 400b may include a curved magnet 402b and a curved coil 404b. In a non-limiting example, the curved magnet 402b may be coupled with one or more movable components (e.g., as indicated in FIG. 4B), and the curved coil 404b may be “fixed” in the sense that it may remain stationary relative to tilt/rotation of the curved magnet 402b. It should be understood that, in various other embodiments, the coil may be movable, and the magnet may be fixed.

In the non-limiting example shown in FIG. 4B, electromagnetic interaction between the curved electromagnetics 400b may cause the curved magnet 402b to tilt (e.g., by Θ degree compensation angle 406b), relative to the curved coil 404b, resulting in a constant magnet-to-coil gap, as indicated by the similarity between gap distance 408b and gap distance 410b.

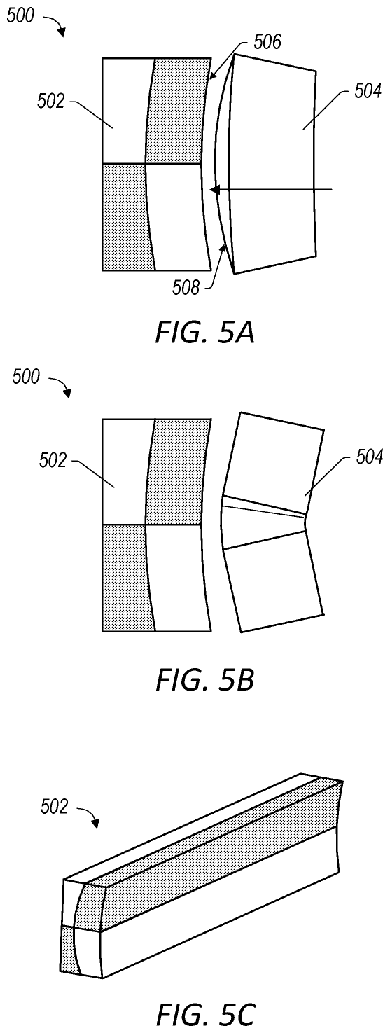

FIGS. 5A-5C illustrate views of an example set of curved electromagnetics 500 that may be included in a camera system, in accordance with some embodiments. FIG. 5A shows a side view of the set of curved electromagnetics 500. FIG. 5B shows a side cross-sectional view of the set of curved electromagnetics 500. FIG. 5C shows a perspective view of a curved magnet of the set of curved electromagnetics 500. In various embodiments, the set of curved electromagnetics 500 may be used in an optical image stabilization (OIS) voice coil motor (VCM) actuator, such as those described herein with reference to FIGS. 1A-4B. Additionally, or alternatively, the set of curved electromagnetics 500, or one or more aspects of the set of curved electromagnetics 500, may be used in a theta-Z correction VCM actuator, such as those described herein with reference to FIGS. 1A-4B.

According to various embodiments, the set of curved electromagnetics 500 may include a concave magnet 502 and a convex coil 504. As indicated in FIG. 5A, the concave magnet 502 may include a curved side (e.g., concave magnet side 506). The convex coil 504 may include a curved side (e.g., convex coil side 508) proximate the curved side of the concave magnet 502.

The curved side of the concave magnet 502 and the curved side of the convex coil 504 may face each other, as indicated in FIGS. 5A-5B. For example, the concave magnet side 506 may face the convex coil side 508. Furthermore, the curved side of the concave magnet 502 may substantially follow the curvature of the curved side of the convex coil 504. For example, the concave magnet side 506 may substantially follow the curvature of the convex coil side 508.

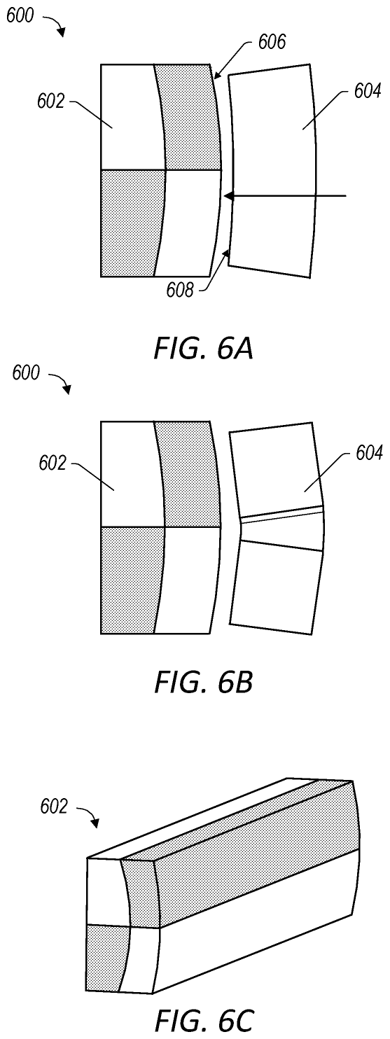

FIGS. 6A-6C illustrate views of another example set of curved electromagnetics 600 that may be included in a camera system, in accordance with some embodiments. FIG. 6A shows a side view of the set of curved electromagnetics 600. FIG. 6B shows a side cross-sectional view of the set of curved electromagnetics 600. FIG. 6C shows a perspective view of a curved magnet of the set of curved electromagnetics 600. In various embodiments, the set of curved electromagnetics 600 may be used in an optical image stabilization (OIS) voice coil motor (VCM) actuator, such as those described herein with reference to FIGS. 1A-4B. Additionally, or alternatively, the set of curved electromagnetics 600, or one or more aspects of the set of curved electromagnetics 600, may be used in a theta-Z correction VCM actuator, such as those described herein with reference to FIGS. 1A-4B.

According to various embodiments, the set of curved electromagnetics 600 may include a convex magnet 602 and a concave coil 604. As indicated in FIG. 6A, the convex magnet 602 may include a curved side (e.g., convex magnet side 606). The concave coil 604 may include a curved side (e.g., concave coil side 608) proximate the curved side of the convex magnet 602.

The curved side of the convex magnet 602 and the curved side of the concave coil 604 may face each other, as indicated in FIGS. 6A-6B. For example, the convex magnet side 606 may face the concave coil side 608. Furthermore, the curved side of the convex magnet 602 may substantially follow the curvature of the curved side of the concave coil 604. For example, the convex magnet side 606 may substantially follow the curvature of the concave coil side 608.

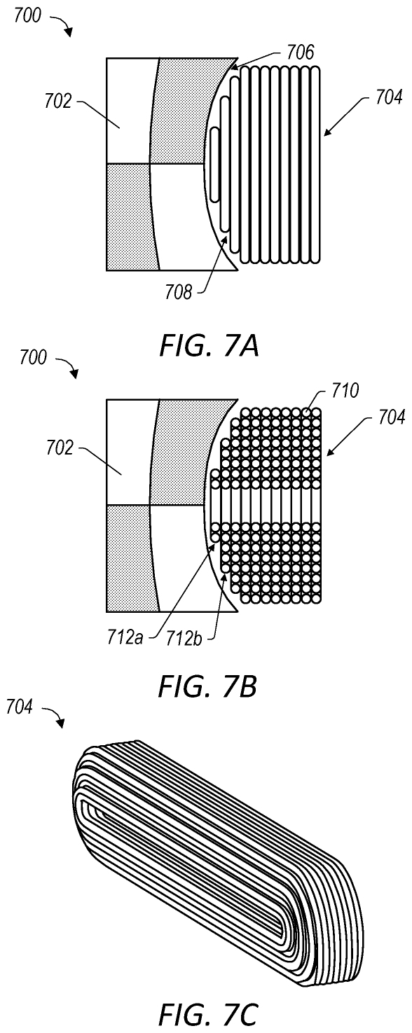

FIGS. 7A-7C illustrate views of yet another example set of curved electromagnetics 700 that may be included in a camera system, in accordance with some embodiments. FIG. 7A shows a side view of the set of curved electromagnetics 700. FIG. 7B shows a side cross-sectional view of the set of curved electromagnetics 700. FIG. 7C shows a perspective view of a curved/stacked coil of the set of curved electromagnetics 700. In various embodiments, the set of curved electromagnetics 700 may be used in an optical image stabilization (OIS) voice coil motor (VCM) actuator, such as those described herein with reference to FIGS. 1A-4B. Additionally, or alternatively, the set of curved electromagnetics 700, or one or more aspects of the set of curved electromagnetics 700, may be used in a theta-Z correction VCM actuator, such as those described herein with reference to FIGS. 1A-4B.

According to various embodiments, the set of curved electromagnetics 700 may include a concave magnet 702 and a convex stacked coil 704. As indicated in FIG. 7A, the concave magnet 702 may include a curved side (e.g., concave magnet side 706). The convex stacked coil 504 may include a curved side (e.g., convex stacked coil side 708) proximate the curved side of the concave magnet 702.

The curved side of the concave magnet 702 and the curved side of the convex stacked coil 704 may face each other, as indicated in FIGS. 7A-7B. For example, the concave magnet side 706 may face the convex stacked coil side 708. Furthermore, the curved side of the concave magnet 702 may substantially follow the curvature of the curved side of the convex stacked coil 704. For example, the concave magnet side 706 may substantially follow the curvature of the convex stacked coil side 708.

As indicated in at least FIG. 7B, the convex stacked coil 704 may be formed of wire strands 710 that are stacked to follow the curvature of the concave magnet 702. As a non-limiting example, a first set 712a of wire strands 710 may be stacked on a second set 712b of wire strands 710, as indicated in FIGS. 7B-7C. The first set 712a and the second set 712b may form two layers of the convex stacked coil 704, and additional layers may be included as shown in the illustrated non-limiting example. Different layers in the stack may be formed using different numbers of wire strands 710, e.g., to form the curvature of the convex stacked coil side 708 that substantially follows the curvature of the concave magnet side 706.

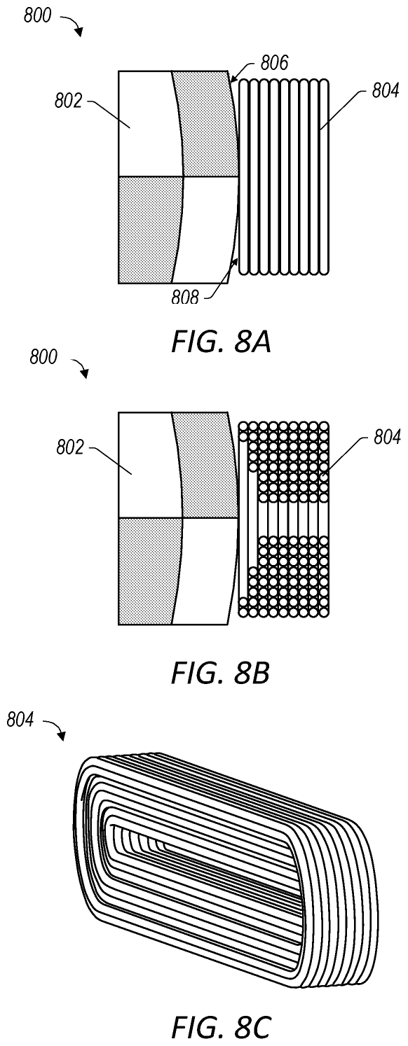

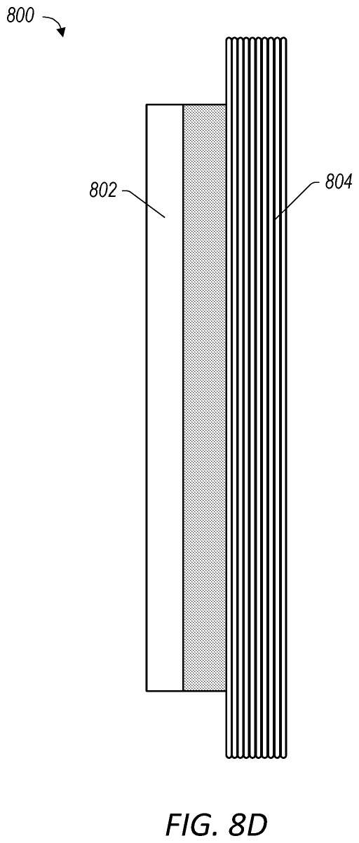

FIGS. 8A-8D illustrate views of another example set of curved electromagnetics 800 that may be included in a camera system, in accordance with some embodiments. FIG. 8A shows a side view of the set of curved electromagnetics 800. FIG. 8B shows a side cross-sectional view of the set of curved electromagnetics 800. FIG. 8C shows a perspective view of a curved/stacked coil of the set of curved electromagnetics 800. FIG. 8D shows a top view of the set of curved electromagnetics 800. In various embodiments, the set of curved electromagnetics 800 may be used in an optical image stabilization (OIS) voice coil motor (VCM) actuator, such as those described herein with reference to FIGS. 1A-4B. Additionally, or alternatively, the set of curved electromagnetics 800, or one or more aspects of the set of curved electromagnetics 800, may be used in a theta-Z correction VCM actuator, such as those described herein with reference to FIGS. 1A-4B.

According to various embodiments, the set of curved electromagnetics 800 may include a convex magnet 802 and a concave stacked coil 804. As indicated in FIG. 8A, the convex magnet 802 may include a curved side (e.g., convex magnet side 806). The concave stacked coil 804 may include a curved side (e.g., concave stacked coil side 808) proximate the curved side of the convex magnet 802.

The curved side of the convex magnet 802 and the curved side of the concave stacked coil 804 may face each other, as indicated in FIGS. 8A-8B. For example, the convex magnet side 806 may face the concave stacked coil side 808. Furthermore, the curved side of the convex magnet 802 may substantially follow the curvature of the curved side of the concave stacked coil 804. For example, the convex magnet side 806 may substantially follow the curvature of the concave stacked coil side 808. In various embodiments, the concave stacked coil 804 may be formed of wire strands that are stacked to follow the curvature of the convex magnet 802, e.g., as similarly discussed with reference to the convex stacked coil 702 in FIGS. 7A-7C.

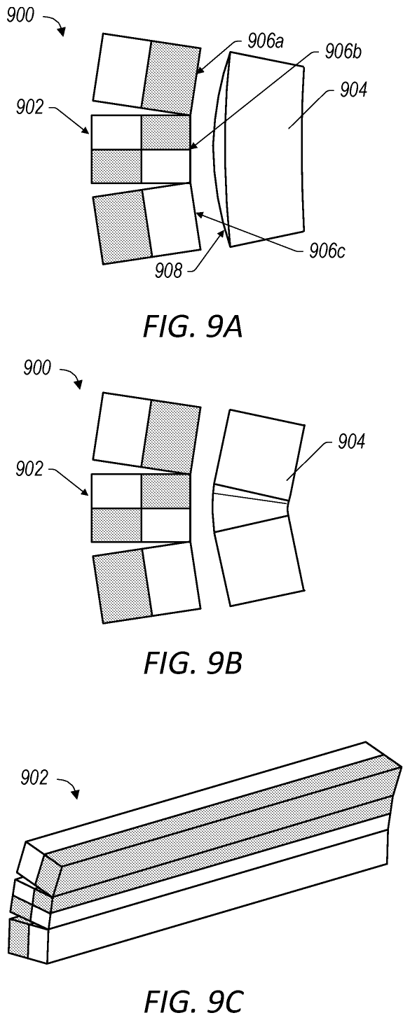

FIGS. 9A-9C illustrate views of yet another example set of curved electromagnetics 900 that may be included in a camera system, in accordance with some embodiments. FIG. 9A shows a side view of the set of curved electromagnetics 900. FIG. 9B shows a side cross-sectional view of the set of curved electromagnetics 900. FIG. 9C shows a perspective view of a curved magnet stack of the set of curved electromagnetics 900. In various embodiments, the set of curved electromagnetics 900 may be used in an optical image stabilization (OIS) voice coil motor (VCM) actuator, such as those described herein with reference to FIGS. 1A-4B. Additionally, or alternatively, the set of curved electromagnetics 900, or one or more aspects of the set of curved electromagnetics 900, may be used in a theta-Z correction VCM actuator, such as those described herein with reference to FIGS. 1A-4B.

According to various embodiments, the set of curved electromagnetics 900 may include a concave magnet stack 902 and a convex coil 904. As indicated in FIG. 9A, the concave magnet stack 902 may include multiple magnets arranged in a stacked manner and oriented so as to form a curved side 906 (or otherwise a side that in effect is the same as, or similar to, a curved side). For example, in some non-limiting embodiments, the curved side 906 may be formed from a first side 906a of a first magnet, a second side 906b of a second magnet, and a third side 906c of a third magnet, as indicated in FIGS. 9A-9C. The second magnet (and second side 906b) may be positioned, in a direction parallel to an optical axis (e.g., optical axis 106 in FIG. 1A) of the camera system, between the first magnet (and first side 906a) and the third magnet (and third side 906c).

In various embodiments, each of the first magnet and the third magnet may be positioned at a respective non-zero angle relative to the second magnet. According to some embodiments, the second magnet may be a dual pole magnet, and the first magnet and the second magnet may be single pole magnets. In FIGS. 9A-9C, the shaded region(s) and the unshaded region(s) of a magnet may represent different magnetic polarities (e.g., north vs. south). In various embodiments, the magnets in the stack may be arranged such that the dual polarization of the second magnet may align an interpolar region (e.g., a region between a pole at the first side 906a and an opposite pole at the third side 906c) with the center of the convex coil 904.

According to various embodiments, the convex coil 904 may include a curved side (e.g., convex coil side 908) proximate the curved side 906 of the concave magnet stack 902. The curved side of the concave magnet stack 902 and the curved side of the convex coil 904 may face each other, as indicated in FIGS. 9A-9B. For example, the concave magnet stack side 906 may face the convex coil side 908. Furthermore, the curved side of the concave magnet stack 902 may substantially follow the curvature of the curved side of the convex coil 904. For example, the concave magnet stack side 906 may substantially follow the curvature of the convex coil side 908.

FIGS. 10A-10B illustrate views of still yet another example set of curved electromagnetics 1000 that may be included in a camera system, in accordance with some embodiments. FIG. 10A shows a top view of the set of curved electromagnetics 1000 as used in the camera system for theta-Z correction/compensation. FIG. 10B shows a perspective view of the set of curved electromagnetics 1000. In various embodiments, the set of curved electromagnetics 1000 may be used in a theta-Z voice coil motor (VCM) actuator, such as those described herein with reference to FIGS. 1A-4B. Additionally, or alternatively, the set of curved electromagnetics 1000, or one or more aspects of the set of curved electromagnetics 1000, may be used in an optical image stabilization (OIS) VCM actuator, such as those described herein with reference to FIGS. 1A-4B.

In various embodiments, the set of curved electromagnetics 1000 may include a convex magnet 1002 and a concave coil 1004. As indicated in FIG. 10A, the convex magnet 1002 may include a curved side (e.g., convex magnet side 1006). The concave coil 1004 may include a curved side (e.g., concave coil side 1008) proximate the curved side of the convex magnet 1002.

The curved side of the convex magnet 1002 and the curved side of the concave coil 1004 may face each other, as indicated in FIGS. 10A-10B. For example, the convex magnet side 1006 may face the concave coil side 1008. Furthermore, the curved side of the convex magnet 1002 may substantially follow the curvature of the curved side of the concave coil 1004. For example, the convex magnet side 1006 may substantially follow the curvature of the concave coil side 1008.

As indicated in FIG. 10A, the camera system may include a movable component 1010 (e.g., an autofocus (AF) module shield can), and a lens group 1012 fixedly coupled with the movable component 1010. In various embodiments, the camera system may include multiple sets of the curved electromagnetics 1000. In the non-limiting example shown in FIG. 10A, the camera system includes four sets of the curved electromagnetics 1000, with each set of electromagnetics 1000 located at a respective corner of the movable component 1010 (and/or a respective corner of the camera system). In some embodiments, the convex magnets 1002 may be attached to the movable component 1010, and the concave coils 1004 may be attached to one or more stationary components (not shown in FIG. 10A).

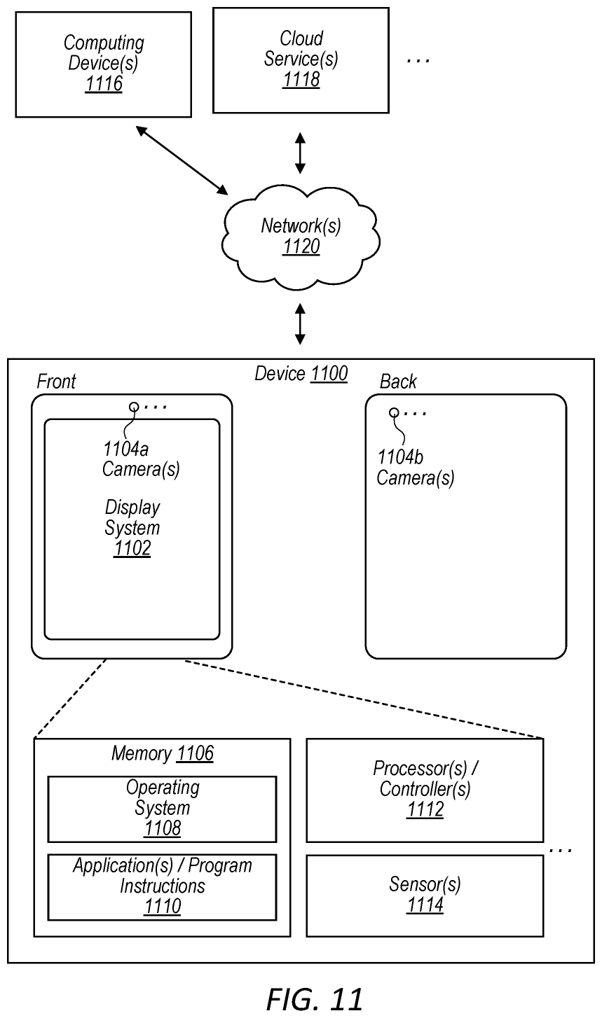

FIG. 11 illustrates a schematic representation of an example environment comprising a device 1100 that may include one or more cameras. For example, the device 1100 may include a camera system with curved electromagnetics, e.g., as described herein with reference to FIGS. 1A-10B. In some embodiments, the device 1100 may be a mobile device and/or a multifunction device. In various embodiments, the device 1100 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 1100 may include a display system 1102 (e.g., comprising a display and/or a touch-sensitive surface) and/or one or more cameras 1104. In some non-limiting embodiments, the display system 1102 and/or one or more front-facing cameras 1104a may be provided at a front side of the device 1100, e.g., as indicated in FIG. 11. Additionally, or alternatively, one or more rear-facing cameras 1104b may be provided at a rear side of the device 1100. In some embodiments comprising multiple cameras 1104, some or all of the cameras 1104 may be the same as, or similar to, each other. Additionally, or alternatively, some or all of the cameras 1104 may be different from each other. In various embodiments, the location(s) and/or arrangement(s) of the camera(s) 1104 may be different than those indicated in FIG. 11.

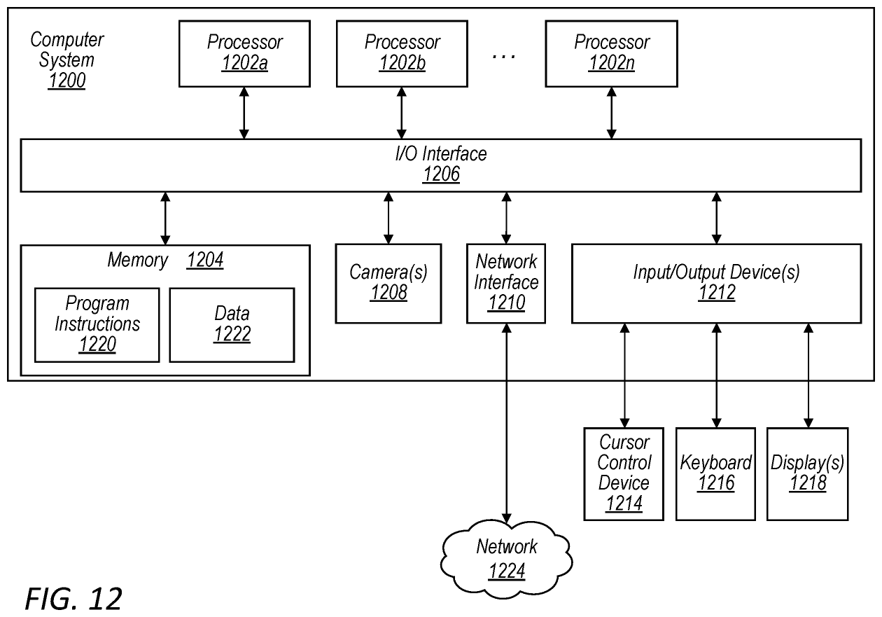

Among other things, the device 1100 may include memory 1106 (e.g., comprising an operating system 1108 and/or application(s)/program instructions 1110), one or more processors and/or controllers 1112 (e.g., comprising CPU(s), memory controller(s), display controller(s), and/or camera controller(s), etc.), and/or one or more sensors 1114 (e.g., orientation sensor(s), proximity sensor(s), and/or position sensor(s), etc.). In some embodiments, the device 1100 may communicate with one or more other devices and/or services, such as computing device(s) 1116, cloud service(s) 1118, etc., via one or more networks 1120. For example, the device 1100 may include a network interface (e.g., network interface 1210 in FIG. 12) that enables the device 1100 to transmit data to, and receive data from, the network(s) 1120. Additionally, or alternatively, the device 1100 may be capable of communicating with other devices via wireless communication using any of a variety of communications standards, protocols, and/or technologies.

FIG. 12 illustrates a schematic block diagram of an example environment comprising a computer system 1200 that may include a camera system with curved electromagnetics, e.g., as described herein with reference to FIGS. 1A-11. In addition, computer system 1200 may implement methods for controlling operations of the camera and/or for performing image processing on images captured with the camera. In some embodiments, the device 1100 (described herein with reference to FIG. 11) may additionally, or alternatively, include some or all of the functional components of the described herein.

The computer system 1200 may be configured to execute any or all of the embodiments described above. In different embodiments, computer system 1200 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1200 includes one or more processors 1202 coupled to a system memory 1204 via an input/output (I/O) interface 1206. Computer system 1200 further includes one or more cameras 1208 coupled to the I/O interface 1206. Computer system 1200 further includes a network interface 1210 coupled to I/O interface 1206, and one or more input/output devices 1212, such as cursor control device 1214, keyboard 1216, and display(s) 1218. In some cases, it is contemplated that embodiments may be implemented using a single instance of computer system 1200, while in other embodiments multiple such systems, or multiple nodes making up computer system 1200, may be configured to host different portions or instances of embodiments. For example, in one embodiment some elements may be implemented via one or more nodes of computer system 1200 that are distinct from those nodes implementing other elements.

In various embodiments, computer system 1200 may be a uniprocessor system including one processor 1202, or a multiprocessor system including several processors 1202 (e.g., two, four, eight, or another suitable number). Processors 1202 may be any suitable processor capable of executing instructions. For example, in various embodiments processors 1202 may be general-purpose or embedded processors implementing any of a variety of instruction set architectures (ISAs), such as the x86, PowerPC, SPARC, or MIPS ISAs, or any other suitable ISA. In multiprocessor systems, each of processors 1202 may commonly, but not necessarily, implement the same ISA.

System memory 1204 may be configured to store program instructions 1220 accessible by processor 1202. In various embodiments, system memory 1204 may be implemented using any suitable memory technology, such as static random access memory (SRAM), synchronous dynamic RAM (SDRAM), nonvolatile/Flash-type memory, or any other type of memory. Additionally, existing camera control data 1222 of memory 1204 may include any of the information or data structures described above. In some embodiments, program instructions 1220 and/or data 1222 may be received, sent, or stored upon different types of computer-accessible media or on similar media separate from system memory 1204 or computer system 1200. In various embodiments, some or all of the functionality described herein may be implemented via such a computer system 1200.

In one embodiment, I/O interface 1206 may be configured to coordinate I/O traffic between processor 1202, system memory 1204, and any peripheral devices in the device, including network interface 1210 or other peripheral interfaces, such as input/output devices 1212. In some embodiments, I/O interface 1206 may perform any necessary protocol, timing, or other data transformations to convert data signals from one component (e.g., system memory 1204) into a format suitable for use by another component (e.g., processor 1202). In some embodiments, I/O interface 1206 may include support for devices attached through various types of peripheral buses, such as a variant of the Peripheral Component Interconnect (PCI) bus standard or the Universal Serial Bus (USB) standard, for example. In some embodiments, the function of I/O interface 1206 may be split into two or more separate components, such as a north bridge and a south bridge, for example. Also, in some embodiments some or all of the functionality of I/O interface 1206, such as an interface to system memory 1204, may be incorporated directly into processors 1202.

Network interface 1210 may be configured to allow data to be exchanged between computer system 1200 and other devices attached to a network 1224 (e.g., carrier or agent devices) or between nodes of computer system 1200. Network 1224 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1210 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output device(s) 1212 may, in some embodiments, include one or more display terminals, keyboards, keypads, touchpads, scanning devices, voice or optical recognition devices, or any other devices suitable for entering or accessing data by one or more computer systems 1200. Multiple input/output devices 1212 may be present in computer system 1200 or may be distributed on various nodes of computer system 1200. In some embodiments, similar input/output devices may be separate from computer system 1200 and may interact with one or more nodes of computer system 1200 through a wired or wireless connection, such as over network interface 1210.

Those skilled in the art will appreciate that computer system 1200 is merely illustrative and is not intended to limit the scope of embodiments. In particular, the computer system and devices may include any combination of hardware or software that can perform the indicated functions, including computers, network devices. Internet appliances, PDAs, wireless phones, pagers, etc. Computer system 800 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 800 may be transmitted to computer system 800 via transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR. RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
a lens group;
an image sensor; and
one or more voice coil motor (VCM) actuators for rotating at least one of the lens group or the image sensor, wherein the one or more VCM actuators comprise:
a magnet-coil group having curved electromagnetics, wherein the magnet-coil group comprises:
one or more magnets forming a first curvature of the curved electromagnetics; and
one or more coils forming a second curvature of the curved electromagnetics, wherein the one or more coils are positioned proximate the one or more magnets such that, when driven with an electric current, the one or more coils are capable of electromagnetically interacting with the one or more magnets to produce Lorentz forces that rotate the at least one of the lens group or the image sensor;
wherein one of the first curvature and the second curvature is convex, and the other of the first curvature and the second curvature is concave.

2. The camera of claim 1, wherein:
the one or more magnets comprise a concave side having the first curvature;
the one or more coils comprise a convex side having the second curvature; and
the concave side faces the convex side.

3. The camera of claim 1, wherein:
the one or more magnets comprise a convex side having the first curvature;
the one or more coils comprise a concave side having the second curvature; and
the convex side faces the concave side.

4. The camera of claim 1, wherein:
the first curvature traces a first arc; and
the second curvature traces a second arc that is concentric with the first arc.

5. The camera of claim 1, wherein:
the one or more magnets comprise a dual pole magnet that has a first curved side having the first curvature;
the one or more coils comprise a coil that has a second curved side having the second curvature; and
the first curved side faces the second curved side.

6. The camera of claim 1, wherein:
the one or more magnets comprise multiple magnets arranged in a curved magnet stack;
the curved magnet stack has a first curved side having the first curvature;
the one or more coils comprise a coil that has a second curved side having the second curvature; and
the first curved side faces the second curved side.

7. The camera of claim 6, wherein the multiple magnets comprise:
a first single pole magnet;
a second single pole magnet; and
a dual pole magnet positioned, in a direction parallel to an optical axis of the camera, between the first single pole magnet and the second single pole magnet.

8. The camera of claim 1, wherein the one or more coils comprise a stacked coil that has wire strands stacked to form the second curvature.

9. The camera of claim 1, wherein the one or more VCM actuators are configured to rotate the lens group, together with the image sensor, about multiple axes orthogonal to an optical axis of the camera.

10. The camera of claim 1, wherein the one or more VCM actuators are configured to rotate the lens group, together with the image sensor, about an axis parallel to an optical axis of the camera.

11. A device, comprising:
one or more processors;
memory storing program instructions executable by the one or more processors to control operations of a camera; and
the camera, comprising:
a lens group;
an image sensor; and
one or more voice coil motor (VCM) actuators for rotating at least one of the lens group or the image sensor, wherein the one or more VCM actuators comprise:
a magnet-coil group having curved electromagnetics, wherein the magnet-coil group comprises:
one or more magnets forming a first curvature of the curved electromagnetics; and
one or more coils forming a second curvature of the curved electromagnetics, wherein the one or more coils are positioned proximate the one or more magnets such that, when driven with an electric current, the one or more coils are capable of electromagnetically interacting with the one or more magnets to produce Lorentz forces that rotate the at least one of the lens group or the image sensor;
wherein one of the first curvature and the second curvature is convex, and the other of the first curvature and the second curvature is concave.

12. The device of claim 11, wherein the one or more VCM actuators comprise at least one of:
an optical image stabilization (OIS) VCM actuator configured to rotate the lens group, together with the image sensor, about multiple axes orthogonal to an optical axis of the camera; or
a theta-Z correction VCM actuator configured to rotate the lens group, together with the image sensor, about an axis parallel to the optical axis.

13. The device of claim 12, wherein:
the one or more VCM actuators comprise the OIS VCM actuator;
the magnet-coil group is a first magnet-coil group of the OIS VCM actuator and is located at a first side of the camera; and
the OIS VCM actuator further comprises:
a second magnet-coil group located at a second side of the camera;
a third magnet-coil group located at a third side of the camera opposite the first side; and
a fourth magnet-coil group located at a fourth side of the camera opposite the second side;
wherein each of the second magnet-coil group, the third magnet-coil group, and the fourth magnet-coil group has curved electromagnetics.

14. The device of claim 12, wherein:
the one or more VCM actuators comprise the theta-Z correction VCM actuator;
the magnet-coil group is a first magnet-coil group of the theta-Z correction VCM actuator and is located at a first corner portion of the camera;
the theta-Z correction VCM actuator further comprises:
a second magnet-coil group located at a second corner portion of the camera;
a third magnet-coil group located at a third corner portion of the camera that is diagonal to the first corner portion; and
a fourth magnet-coil group located at a fourth corner portion of the camera that is diagonal to the second corner portion;
wherein each of the second magnet-coil group, the third magnet-coil group, and the fourth magnet-coil group has curved electromagnetics.

15. The device of claim 11, wherein:
the one or more magnets are coupled with a movable component of the camera; and
the one or more coils are coupled with a stationary component of the camera.

16. The device of claim 11, wherein:
the one or more magnets are coupled with a stationary component of the camera; and
the one or more coils are coupled with a movable component of the camera.

17. The device of claim 11, wherein:
the first curvature traces a first arc; and
the second curvature traces a second arc that is concentric with the first arc.

18. A system, comprising:
one or more voice coil motor (VCM) actuators for rotating at least one of a lens group or an image sensor of a camera, wherein the one or more VCM actuators comprise:
a magnet-coil group having curved electromagnetics, wherein the magnet-coil group comprises:
one or more magnets forming a first curvature of the curved electromagnetics; and
one or more coils forming a second curvature of the curved electromagnetics, wherein the one or more coils are positioned proximate the one or more magnets such that, when driven with an electric current, the one or more coils are capable of electromagnetically interacting with the one or more magnets to produce Lorentz forces that rotate the at least one of the lens group or the image sensor;
wherein one of the first curvature and the second curvature is convex, and the other of the first curvature and the second curvature is concave.

19. The system of claim 18, wherein:
the one or more magnets comprise a concave side having the first curvature;
the one or more coils comprise a convex side having the second curvature; and
the concave side faces the convex side.

20. The system of claim 18, wherein:
the one or more magnets comprise a convex side having the first curvature;
the one or more coils comprise a concave side having the second curvature; and
the convex side faces the concave side.
